(19) United States
(12) Patent Application Publication
(10) Pub. No.: US 2014/0082263 A1
(43) Pub. Date: Mar. 20, 2014

(54) MEMORY SYSTEM

(71) Applicants: Shigeaki Iwasa, Kawasaki-shi (JP); Kohei Oikawa, Kawasaki-shi (JP)

(72) Inventors: Shigeaki Iwasa, Kawasaki-shi (JP); Kohei Oikawa, Kawasaki-shi (JP)

(21) Appl. No.: 14/004,788

(22) PCT Filed: Sep. 20, 2011
(86) PCT No.: PCT/JP2011/071935

§ 371 Date: Dec. 5, 2013

(30) Foreign Application Priority Data
Apr. 5, 2011 (JP) 2011-083671

(51) Int. Cl. G06F 12/02

(52) U.S. Cl. CPC G06F 12/0246
USPC 711/103

(57) ABSTRACT

According to one embodiment, a memory system includes a plurality of nonvolatile memories, an address converter, a plurality of channel controllers, and a controller. The plurality of nonvolatile memories is connected to respective channels. The address converter converts a logical address of a read request into a physical address of the nonvolatile memories. Each of the channel controllers is provided to each of the channels. Each of the channel controllers has a plurality of queues, each queues stores at least two read request. The controller selects a queue which stores no read request, and transfers the read request to the selected queue.

### CROSS-REFERENCE TO RELATED APPLICATIONS

This application is based upon and claims the benefit of priority from prior Japanese Patent Application No. 2011-083671, filed Apr. 5, 2011, the entire contents of which are incorporated herein by reference.

### FIELD

Embodiments described herein relate generally to a memory system.

### BACKGROUND

An SSD includes a plurality of banks, and each bank is comprised of, e.g., a plurality of NAND flash memories. The banks are connected to channels, respectively. A necessary bandwidth is ensured by parallelly reading or writing data from or in the respective banks using a plurality of banks and a plurality of channels.

A NAND flash memory performs data read and write for each page. A dynamic memory (DRAM) is used so that a low-speed NAND flash memory can efficiently transfer data to a high-speed host interface. A work area for the DRAM requires a capacity of several hundred MB. This makes it difficult to reduce the SSD manufacturing cost.

### BRIEF DESCRIPTION OF THE DRAWINGS

FIG. 1 is a block diagram showing the read system of a memory system according to an embodiment;

FIG. 2 is a view schematically showing part of the system in FIG. 1; and

FIG. 3 is a flowchart for explaining an operation in FIGS. 1 and 2.

### DETAILED DESCRIPTION

In general, according to one embodiment, a memory system includes a plurality of nonvolatile memories, an address converter, a plurality of channel controllers, and a controller. The plurality of nonvolatile memories is connected to respective channels. The address converter converts a logical address of a read request into a physical address of the nonvolatile memories. Each of the channel controllers is provided to each of the channels. Each of the channel controllers has a plurality of queues, each queues stores at least two read request. The controller selects a queue which stores no read request, and transfers the read request to the selected queue.

An embodiment will now be described with reference to the accompanying drawings.

The embodiment has a feature in which data are read from a plurality of banks without using a DRAM. For example, when one bank is accessed intensively in access to a plurality of banks, a wait occurs and no required performance can be obtained. The embodiment can avoid the concentration of bank access and implement high-speed data read using a small-capacity work area. An SSD can therefore be configured without a DRAM, achieving SATA Gen. 3 (6 Gbps=600 MB/s).

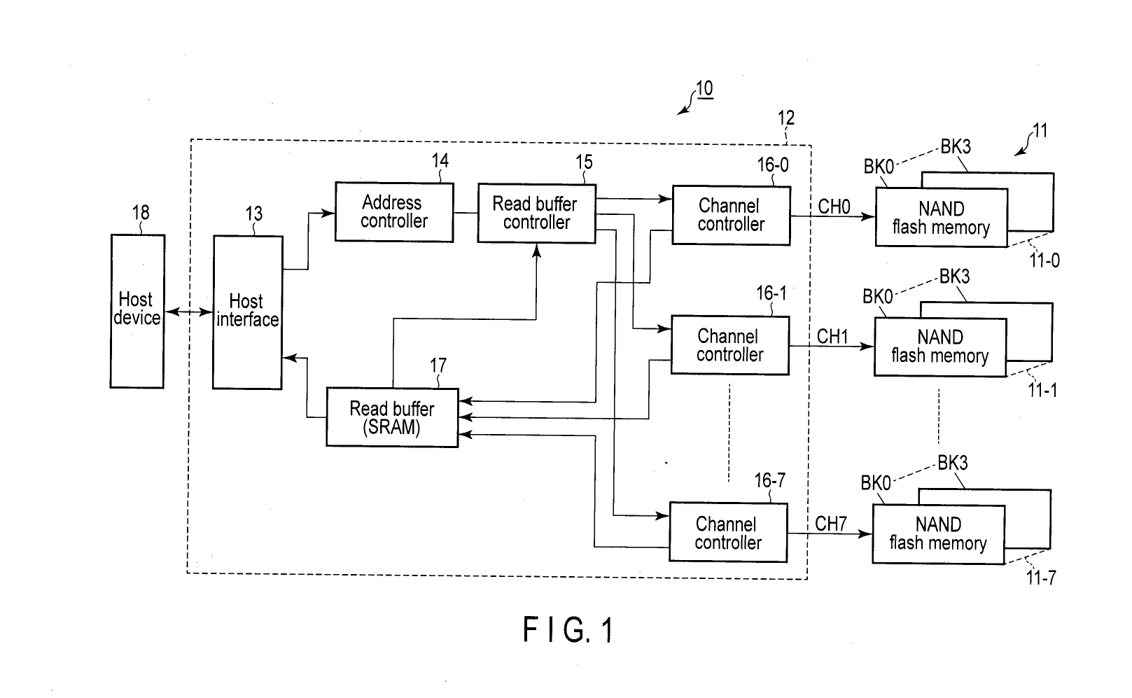

FIG. 1 shows the arrangement of the read system of a memory system according to the embodiment. The arrangement of the write system is not illustrated.

Referring to FIG. 1, an SSD 10 serving as a memory system includes a NAND memory 11 formed from a plurality of NAND flash memories, and a drive control circuit 12.

The NAND memory 11 includes, e.g., eight bank groups 11-0 and 11-1 to 11-7 which perform eight parallel operations. The eight bank groups 11-0 and 11-1 to 11-7 are connected to the drive control circuit 12 via eight channels CH0 and CH1 to CH7. Each of bank groups 11-0 and 11-1 to 11-7 is formed from, e.g., four banks BK0 to BK3 capable of interleaving banks. Each of banks BK0 to BK3 is formed from a NAND flash memory.

The drive control circuit 12 includes, e.g., a host interface 13, an address converter 14, a read buffer controller 15, channel controllers 16-0 and 16-1 to 16-7, and a read buffer 17.

The host interface 13 interfaces with a host device 18. More specifically, the host interface 13 receives a read command issued from the host device 18, and supplies it to the address converter 14. Further, the host interface 13 transfers read data supplied from the read buffer 17 to the host device 18.

The address converter 14 converts a logical address added to the command supplied from the host interface 13 into the physical address of the NAND memory 11. The address converter 14 converts only the logical block address of the first cluster of the NAND memory 11 out of a read command having a large data length, which will be described later. The address converter 14 converts subsequent addresses immediately before the read command is transferred to channel controllers 16-0 to 16-7.

A cluster is a unit by which a logical address is converted into a physical address. One cluster generally includes a plurality of sectors having successive logical addresses. A sector is a unit by which a logical address is added to data. A page is generally the read/write unit of a NAND flash memory, and is constituted from a plurality of clusters.

The read buffer controller 15 sequentially receives a physical address converted by the address converter 14 and a read command, and supplies the physical address and read command to one of channel controllers 16-0 to 16-7 in accordance with the physical address and the free space of the queue (to be described later). That is, the read buffer controller 15 can hold a plurality of physical addresses and a plurality of read commands.

Based on the physical address and read command, the read buffer controller 15 allocates an area in the read buffer 17 formed from, e.g., a static RAM (SRAM), in order to hold data read from the NAND memory 11. A physical address and read command for which the area is allocated serve as candidates to be transferred to channel controllers 16-0 to 16-7.

Channel controllers 16-0 and 16-1 to 16-7 are connected to bank groups 11-0 and 11-1 to 11-7 via channels CH0 and CH1 to CH7, respectively. Channel controllers 16-0 and 16-1 to 16-7 have channels CH0 to CH7, and queues each segmented for banks BK0 to BK3. Reference symbols Q0 to Q3 denote queues corresponding to banks BK0 to BK3. Each of queues Q0 to Q3 corresponding to banks BK0 to BK3 has two entries which receive a command.

The read buffer 17 is a memory which holds data read from the NAND memory 11. The read buffer 17 is formed from, e.g., a static RAM (SRAM). The read buffer 17 has a storage capacity almost double the data size simultaneously readable from the NAND memory 11, which will be described later.

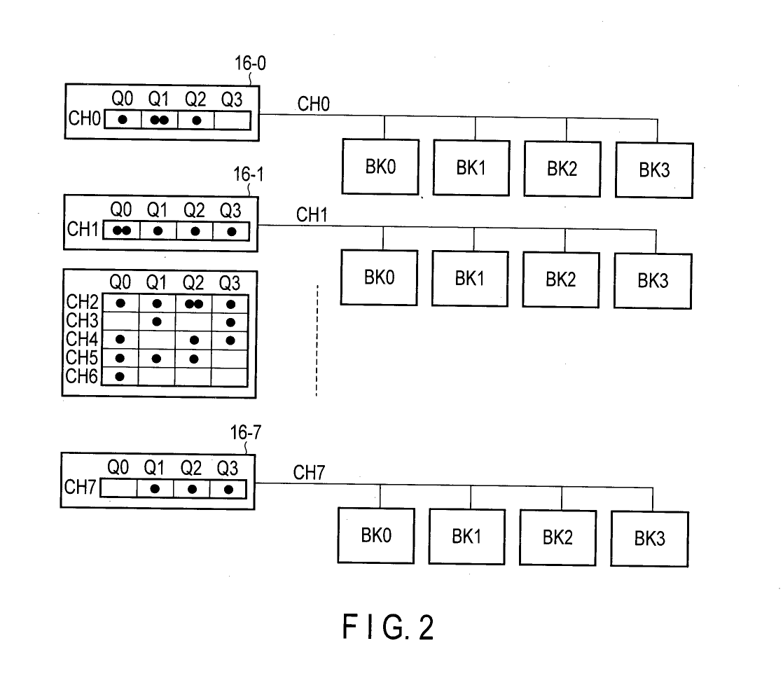

FIG. 2 schematically shows the relationship between channels CH0 to CH7 and queues Q0 to Q3 corresponding to banks BK0 to BK3. More specifically, each of channel controllers 16-0 and 16-1 to 16-7 has queues Q0 to Q3. The two entries of each of queues Q0 to Q3 can hold a command supplied from the read buffer controller 15. In FIG. 2, a filled circle indicates the number of commands in the entry. A blank without a filled circle means that no command is held and the queue is empty.

At least one command held in queues Q0 to Q3 is executed in turn every time processing of banks BK0 to BK3 connected to a corresponding one of channels CH0 and CH1 to CH7 ends. For example, queue Q1 corresponding to channel CH0 holds two read commands. A command held first out of the held commands is executed after the end of the read operation of bank BK1 connected to channel CH0. Data read by the read operation of bank BK1 is supplied to the read buffer 17 via channel CH0 and channel controller 16-0, and held in an area which has been allocated by the read buffer controller 15 in correspondence with the command. Then, the remaining read command held in the entry of queue Q1 is executed.

Channel controllers 16-0 to 16-7 and bank groups 11-0 and 11-1 to 11-7 can operate parallelly. The read buffer controller 15 can simultaneously receive data read from the eight banks via the eight channels CH0 to CH7 and the eight channel controllers 16-0 to 16-7.

The embodiment can optimize the bandwidth by appropriately assigning commands to queues Q0 to Q3 of channel controllers 16-0 to 16-7 shown in FIG. 2. The read buffer controller 15 preferentially assigns a command to an empty queue based on the physical address.

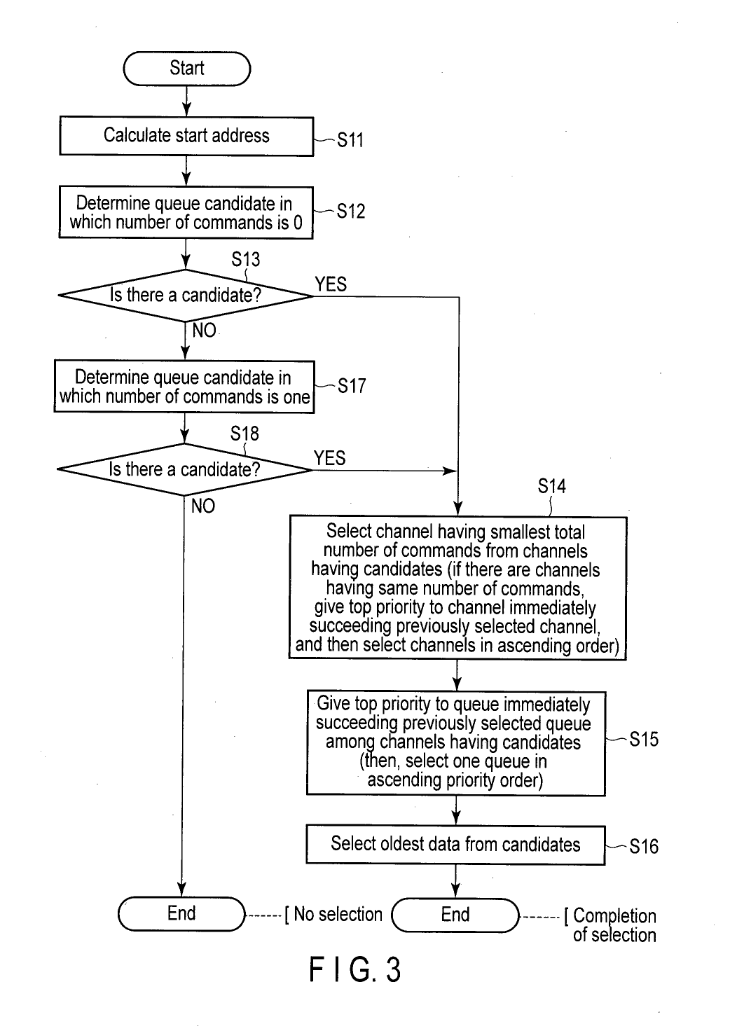

A command assignment operation to queues Q0 to Q3 will be explained with reference to FIGS. 2 and 3.

FIG. 3 shows the operation of the drive control circuit 12. As described above, the drive control circuit 12 supplies a read command from the host device 18 to the address converter 14 via the host interface 13. The address converter 14 converts a logical address added to the command into the physical address of the NAND memory 11 (S11). For a read command having a large data length, only the logical block address of the first cluster of the NAND memory 11 is converted, and subsequent addresses are converted immediately before transfer to the queue upon completion of command selection. Data having a large data length is often distributed and stored in banks connected to adjacent channels. Hence, read processes are highly likely to be parallelized naturally and controlled efficiently without taking account of addresses in selection processing in step S12 and subsequent steps. For this reason, subsequent addresses may not be converted in step S11.

After the address translation, one read command is selected from read commands in the read buffer controller 15 by processing in step S12 and subsequent steps.

First, a bank candidate for saving an address and read command (to be simply referred to as a command) is determined from queues Q0 to Q3 corresponding to each of channels CH0 to CH7 (S12 and S13). More specifically, a queue candidate in which the number of commands is “0” (zero) is determined among queues Q0 to Q3.

In the example shown in FIG. 2, queue Q3 of CH0, queues Q0 and Q2 of CH3, queue Q1 of CH4, queue Q3 of CH5, queues Q1, Q2, and Q3 of CH6, and queue Q0 of CH7 are empty. Commands having addresses corresponding to these queues are determined as candidates.

After step S13, a channel having the smallest total number of commands already held in the queue is selected from channels corresponding to the command candidates (S14).

In the example shown in FIG. 2, the total number of commands in CH0 is four, that of commands in CH3 is two, that of commands in CH4 is three, that of commands in CH5 is three, that of commands in CH6 is one, and that of commands in CH7 is three. If there is a command candidate corresponding to CH6, CH6 having the smallest number of commands is selected.

If there are a plurality of channels having the smallest number of commands, one channel is selected by giving top priority to, e.g., a channel immediately succeeding the previously selected channel.

After a channel having the smallest number of commands is selected in the above-described way, a queue in the selected channel is selected (S15). In this case, one queue is selected by giving top priority to a queue immediately succeeding the previously selected queue. In the example shown in FIG. 2, CH6 is selected. Since the previously selected queue in CH6 is Q0 which has already held a command, one queue is selected by giving top priority to Q1 next to Q0.

Then, the oldest read command is selected from the remaining candidates in the read buffer controller 15, and transferred to the selected Q1 (S16).

If it is determined in step S13 that there is no queue candidate in which the number of commands is 0, a queue candidate in which the number of commands is one is determined (S17 and S18). In the example shown in FIG. 2, each of queues Q0 and Q2 of CH0, queues Q1, Q2, and Q3 of CH1, queues Q0, Q1, and Q3 of CH2, queues Q0, Q2, and Q3 of CH4, queues Q0, Q1, and Q2 of CH5, queue Q0 of CH6, and queues Q1, Q2, and Q3 of CH7 holds one command. Thereafter, the processes in steps S14 to S16 are executed in the above-described manner.

If it is determined in step S18 that there is no queue candidate which holds one command, it is determined that any command in the read buffer controller 15 need not be transferred to the queue. If a new read command is transferred from the host device or processing of any command held in the queue ends, the processing in FIG. 3 is executed again.

As described above, queues Q0 to Q3 of each of channel controllers 16-0 to 16-7 hold read commands. Read commands held in queues Q0 to Q3 are sequentially executed every time the read operation of the bank of a corresponding NAND memory 11 ends.

Data read from the respective banks are transferred via corresponding channels CH0 to CH7 and channel controllers 16-0 to 16-7 to areas which have been allocated in the read buffer 17 in correspondence with commands. The data transferred to the respective areas of the read buffer 17 are rearranged in accordance with addresses, and supplied to the host device 18 via the host interface 13.

According to the embodiment, queues Q0 to Q3 for holding commands in correspondence with banks BK0 to BK3 are arranged in each of channel controllers 16-0 to 16-7 connected to channels CH0 to CH7 each arranged in correspondence with a plurality of banks each formed from of the NAND memory 11. A command is preferentially supplied to a queue having the smallest number of held commands out of queues Q0 to Q3. Therefore, queued commands can be reduced, and commands can be executed quickly. This can also shorten the time during which data read from the bank and transferred to the read buffer 17 stays in the read buffer 17.

A long stay time of data in the read buffer 17 requires a large-capacity read buffer to hold data read from the bank. Thus, forming the read buffer from a DRAM requires a DRAM with a capacity of several to several ten MB.

However, the embodiment can shorten the stay time of data in the read buffer 17 and suppress the capacity of the read buffer 17 to about 1 MB or less. The read buffer 17 can therefore be formed from an SRAM embedded in a logic circuit which forms the drive control circuit 12. This can obviate the need for using, e.g., an expensive DRAM formed from a chip separately from a logic circuit. Accordingly, The SSD 10 can be configured without using a DRAM, reducing the manufacturing cost.

More specifically, when the number of channels is eight, that of banks is four, and one page has 16 KB, the simultaneously readable data size is 8 channels×4 banks×16 KB=512 KB. As long as the read buffer 17 has a capacity double this data size, i.e., a capacity of 1 MB, data held in the read buffer 17 can be transferred to the host device 18 while data is read from the NAND memory 11 and transferred to the read buffer 17. Hence, data can be successively read from the NAND memory 11 and transferred to the host device 18.

In addition, according to the embodiment, a command is preferentially assigned to a queue having a free space, shortening the time till the start of the read operation of the NAND memory after assigning a command to the queue. This can shorten the time until an area in the read buffer 17 is released after allocating it, and also the time until an area is allocated next time in the read buffer 17.

The read buffer controller 15 supplies, to channel controllers 16-0 to 16-7, only read commands for which areas have been allocated in the read buffer 17. Therefore, the read operation waiting time in the NAND memory 11 can be shortened, implementing high-speed read.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A memory system comprising:
a plurality of nonvolatile memories connected to respective channels;
an address converter configured to convert a logical address of a read request into a physical address of a nonvolatile memory;
a plurality of channel controllers each of which is provided to each of the channels, wherein each of the channel controllers has a plurality of queues, each queues stores at least two read request; and
a controller configured to select a queue which stores no read request, and to transfer the read request to the selected queue.

2. The system according to claim 1, wherein the controller selects a queue which has one read request, when there is no queue which stores no read request.

3. The system according to claim 2, wherein the controller selects a channel controller which has smallest number of total read request when there is a plurality of queues which stores no read request, and selects a queue of the selected channel controller.

4. The system according to claim 3, wherein the controller selects a channel controller which succeeds a previously selected channel controller when there is a plurality of channel controllers which has same number of total read request, and selects a queue of the selected channel.

5. The system according to claim 4, wherein
the controller selects a queue succeeding a previously selected queue when selecting a queue in the selected channel.

6. The system according to claim 5, wherein the number of the queues provided in the each channel controllers is corresponding to the number of chips of the nonvolatile memories connected to each channels.

7. The system according to claim 1, further comprising:
a buffer configured to store data read from the nonvolatile memories in response to the read request;
wherein the controller transfers the read request to the queue, and ensure a memory space in the buffer to store the data from the nonvolatile memories read in response to the read request.

8. A method of data read comprising:
converting a logical address of a read request into a physical address of a nonvolatile memory; and
selecting a queue storing the read request from a plurality of queues corresponding to channels of the nonvolatile memory, wherein the selecting is performed based on the number of the read request stored in each of the queues,
wherein the selecting of the queue is performed by selecting a queue having no read request; and
transferring the read request to the selected queue.

9. The method according to claim 8, wherein
the selecting of the queue is performed by selecting a queue which has one read request, when there is no queue which stores no read request.

10. The method according to claim 9, wherein
when there is a plurality of queues which stores no read request, a channel controller which has smallest number of total read request is selected, and a queue is selected from the selected channel controller.

11. The method according to claim 10, wherein
when there is a plurality of channel controllers which has same number of total read request, a channel controller which succeeds a previously selected channel controller is selected, and a queue is selected from the selected channel controller.

12. The method according to claim 11,
transferring the oldest read request to the selected queue.
